(19) United States
(12) Patent Application Publication
(10) Pub. No.: US 2009/0129629 A1
(43) Pub. Date: May 21, 2009

(54) Method And Apparatus For Adaptive Object Detection

(76) Inventors: Po-Feng Cheng, Kaohsiung (TW); Wen-Hao Wang, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 12/016,207

(22) Filed: Jan. 18, 2008

(30) Foreign Application Priority Data
Nov. 21, 2007 (TW) 096144124

(51) Int. Cl. G06K 9/00

(52) U.S. Cl. 382/103

(57) ABSTRACT

Disclosed is a method and apparatus for adaptive object detection, which may be applied in detecting an object having an ellipse feature. The method for adaptive object detection comprises performing an object shape detection based on the extracted foreground from the object; determining whether the object being occluded according to the detected feature statistic information of the object; if the object being not occluded, determining whether to switching object shape detection to ellipse detection; if the object being occluded or necessary to switch to ellipse detection, performing ellipse detection on the foreground; when the foreground being detected to have ellipse features, the object is continuously tracked; and when the current detection being ellipse detection, determining whether the ellipse detection being able to switch back to object shape detection.

### FIELD OF THE INVENTION

The present invention generally relates to a method and apparatus for adaptive object detection.

### BACKGROUND OF THE INVENTION

The human being is of great interest in the video surveillance system; therefore, there are many human detection and tracking algorithms and systems developed for that purpose. The general human detection method usually uses the head detection or human shape detection to find the human form in the video for applications. In the general intelligent surveillance system, the human detection method usually uses human shape detection, ellipse detection or shape mapping.

The human shape detection uses the machine learning to train the system to detect the full human shape, or full human shape and half human shape simultaneously. The template generated by the human shape training may be used to detect the full human shape or half human shape. This approach may effectively detect the human shape in the video. However, when the human shape is occluded, the human shape detection renders useless as the human shape feature constructed in the training cannot be detected.

The ellipse detection is the detection of the human head. The construction of the ellipse template does not require training. Although the model may be constructed off-line in advance and effectively locate the human head in the video, the accuracy of this approach suffers when the human shape is too small.

The shape mapping approach is to construct the shape of the object and then compares with the object boundary found in the current video. If occluded, the object shape is ruined for detection.

There are several approaches for occlusion detection. For example, U.S. Pat. No. 7,110,569 disclosed a method for using time delay neural network to construct human shape template. This method requires a large amount of data to overcome the situation of body occlusion or missing upper body shape. U.S. Pat. No. 6,674,877 disclosed a method of using fuzzy logic to detect self-occlusion. However, this method does not provide any solution for other occlusion situations. U.S. Pat. No. 7,142,600 used the body boundary as the basis for occlusion detection. In addition, there are other methods of using block match combined with Bayesian Decision Theory for occlusion detection and tracking.

### SUMMARY OF THE INVENTION

The exemplary embodiments of the present disclosure provide a method and apparatus for adaptive object detection, applicable to the detection and tracking of objects with ellipse feature in a non-occluded or occluded situation.

In an exemplary embodiment, the present disclosure is directed to a method for adaptive object detection, comprising the steps of performing an object shape detection based on the extracted foreground from an object; determining whether the object being occluded according to the detected feature statistic information of the object; if the object being not occluded, determining whether to switching object shape detection to ellipse detection; if the object being occluded or should be switched to ellipse detection, performing ellipse detection on the foreground; when the foreground being detected to have ellipse features, the object is continuously tracked; and when the current detection being ellipse detection, determining whether the ellipse detection being able to switch back to object shape detection.

In another exemplary embodiment, the present disclosure is directed to an apparatus for adaptive object detection, comprising an object shape detection module, an occlusion detection module, an ellipse detection module, a detection recovery module, and an ellipse feature detection module.

The object shape detection module performs the object shape detection based on the extracted foreground of an object. According to the feature statistic information of the detected object, the occlusion detection module determines whether the object is occluded. If the object is occluded or the object shape detection should be switched to ellipse detection, the ellipse detection module performs the ellipse detection on the foreground object. The ellipse feature detection module determines whether the foreground object has the ellipse feature according to the result of the ellipse detection module. The detection recovery module determines whether the ellipse detection is switched to object shape detection.

The disclosed exemplary embodiments determine, based on closeness between the same object feature statistic information in previous n video images and the current object feature statistic information, whether the object is occluded. The object is occluded in two different ways. The first is the occlusion between an object and another object. The second is that merging of the object and another object. The present disclosure may further compare the closeness between the current human feature statistic information and the neighboring object feature statistic information to detect which occlusion is present.

When the object gradually departs the view range, if the shape of the detected object does not match a length vs. width ratio threshold in the disclosed exemplary embodiments, the object shape detection is switched to ellipse detection to achieve the continuous tracking.

The disclosed exemplary embodiments also determine to switch back to object shape detection after how many videos are processed, based on the current video processing speed, in order to achieve the continuous tracking of the complete shape.

The foregoing and other features, aspects and advantages of the present invention will become better understood from a careful reading of a detailed description provided herein below with appropriate reference to the accompanying drawings.

### BRIEF DESCRIPTION OF THE DRAWINGS

FIG. 1 shows an exemplary flowchart of the method for adaptive object detection, consistent with certain embodiments of the present invention.

FIG. 2 shows an exemplary flowchart of how to determine to switch to ellipse detection when the object is not occluded, consistent with certain embodiments of the present invention.

FIG. 3 shows an exemplary flowchart of how to determine whether the object is occluded, consistent with certain embodiments of the present invention.

FIG. 4 shows an exemplary flowchart of how to determine whether to switch from ellipse detection to object shape detection, consistent with certain embodiments of the present invention.

FIG. 5 shows an exemplary schematic view of an apparatus for adaptive object detection, consistent with certain embodiments of the present invention.

FIG. 6 shows another exemplary schematic view of an apparatus for adaptive object detection, consistent with certain embodiments of the present invention.

### DETAILED DESCRIPTION OF THE PREFERRED EMBODIMENTS

The disclosed embodiments provides the use of switching object detection method to detect the occluded object when an occluded situation occurs in tracking the object, such as human-to-human occlusion, human-to-object occlusion, or human departing the camera range.

The disclosed embodiments appropriately switch between the object shape detection and the ellipse detection. When the object shape is too small and not suitable for the ellipse detection, the full-body object shape detection method is used for detection. When the object shape grower bigger or is occluded, the detection is switched to the ellipse detection for continuous tracking. Before switching the object detection method, the present invention determines whether an occlusion has occurred.

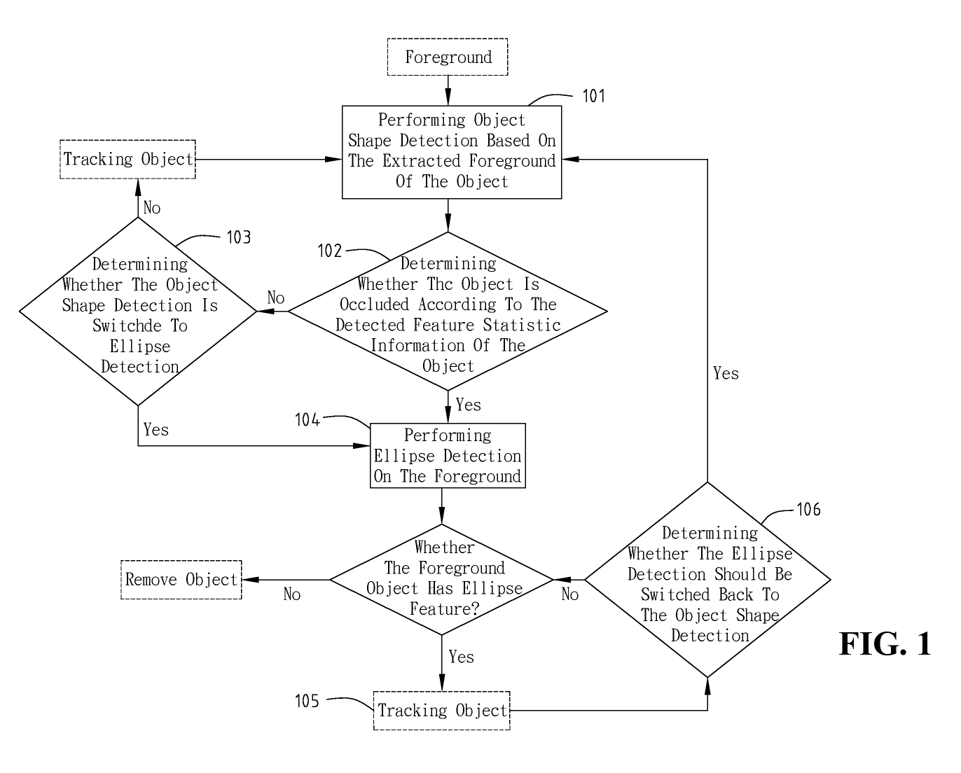

FIG. 1 shows an exemplary flowchart of the method for adaptive object detection, consistent with certain embodiments of the present invention. The method is applicable to the object with ellipse features. Referring to FIG. 1, object shape detection is performed based on the extracted foreground of the object, as shown in step 101. The object shape detection may construct the object shape template through machine learning, and then use the template to compare with the foreground to detect the object shape. The foreground may be extracted from the object for detection, that is, by separating the foreground and the background.

In the step 102, whether the object is occluded is determined according to the detected feature statistic information of the object. There are two types of occlusion. The first type is the occlusion between an object and another object, and the second type is the occlusion between an object and the background. The way to determine the occlusion is to compare the current object feature statistic information with the object feature statistic information of the previous n frames. If the closeness is high, no occlusion is present; otherwise, an occlusion has occurred. For example, the Bhattacharyya distance may be used to indicate the closeness. If the Bhattacharyya distance is smaller than a threshold, the closeness is high; otherwise, the closeness is low. Once an occlusion has occurred, the adaptive object detection method of the present invention will switch appropriately so that the object tracking may be continued.

If no occlusion is present, whether the object shape detection is switched to ellipse detection is further determined, as shown in step 103.

If the object is occluded or the object shape detection is switched to ellipse detection, ellipse detection on the foreground is performed, as shown in step 104. In step 105, whether the foreground object has ellipse feature, such as the shape of a human head, is determined. When the foreground object has the ellipse feature, the object is continuously tracked.

If no ellipse feature, such as the shape of a human head, is detected on the object, and the shape of the object cannot be detected, the object is treated as noise. As shown in FIG. 1, the object is removed to prevent from interfering with neighboring objects.

When the object shape or the ellipse is detected, the features of the detected object shape or ellipse, such as color, texture, boundary, and so on, may be used to predict the new location of the object motion in the next video.

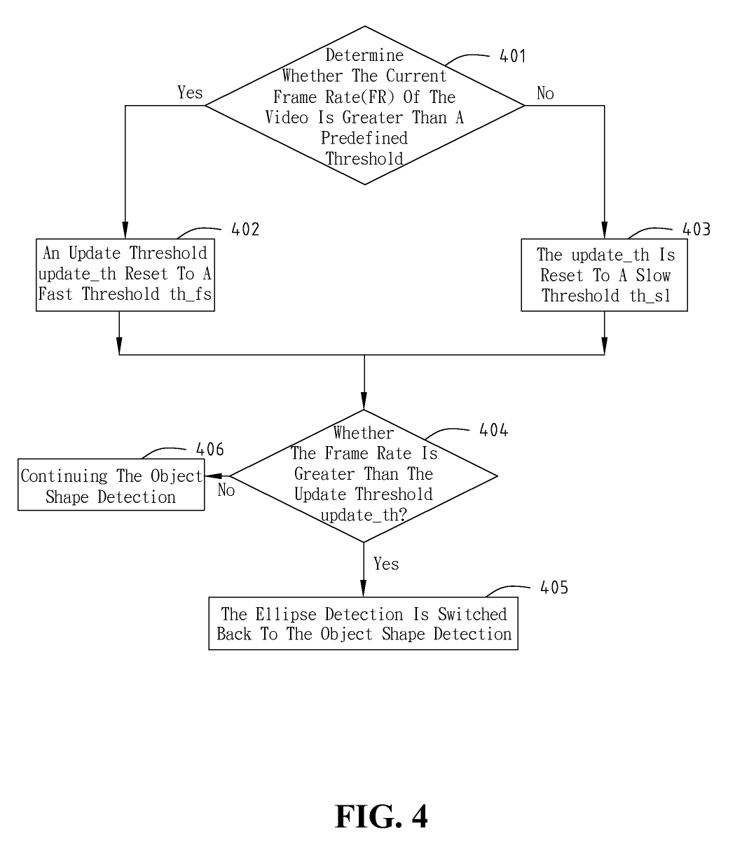

In step 106, whether the ellipse detection should be switched back to the object shape detection is determined. The appropriate switching time for detection method is when the current object tracking method is the ellipse detection. Therefore, when the current object tracking method is the ellipse detection, the present invention may re-perform the object shape detection on the foreground periodically, such as every few frames, to see whether it should switch to the object shape detection. The switching of detection method may be adjusted according to the current video processing speed, which will be further elaborated in FIG. 4.

If the current ellipse detection is switched back to the object shape detection, returns to step 101. On the other hand, if the ellipse detection will continue to track, return to step 105 for detecting whether the foreground object has any ellipse feature.

In step 103, if the detected object shape does not satisfy a certain threshold for the length to width ration, the object shape detection may be switched to ellipse detection. The length to width ration of the object shape may be used to determine whether the object is growing bigger or smaller due to the motion. If the object grows bigger, the implication is that the object is moving from far to near in the field of view (FOV), e.g., walking towards the camera. In this case, the lower part of the object will be out of the FOV. Therefore, it is necessary to switch to ellipse detection for continuous object tracking. Otherwise, the object shape detection may be used for continuous object tracking.

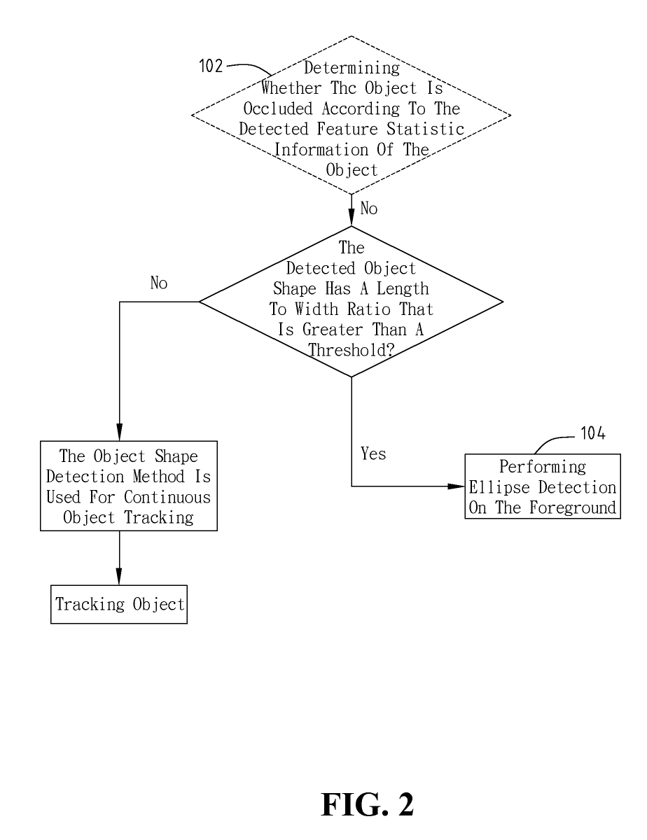

Therefore, when the object is not occluded, the determination of the detection method switching from object shape detection to ellipse detection is shown in FIG. 2. If the detected object shape has a length to width ratio that is greater than a threshold, return to step 104. In other words, the detection method is switched from object shape detection to ellipse detection for continuous object tracking. Otherwise, the object shape detection method is used for continuous object tracking.

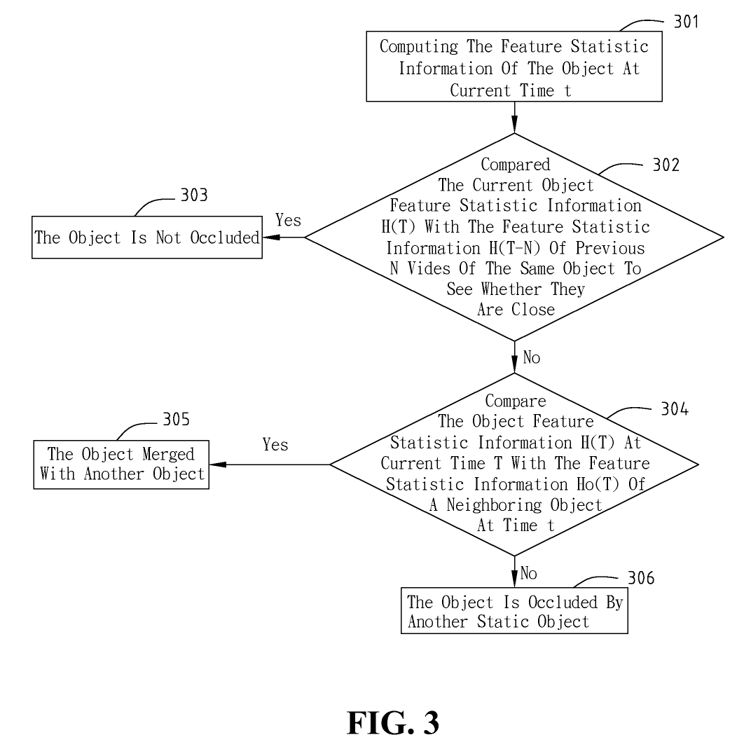

FIG. 3 an exemplary flowchart of how to determine whether the object is occluded, consistent with certain embodiments of the present invention. Referring to FIG. 3, the feature statistic information of the object at current time t is computed, as shown in step 301. The feature statistic information of the object may include, such as, the object color, texture and boundary, and so on. In step 302, the current object feature statistic information H(t) is compared with the feature statistic information H(t−n) of previous n vides of the same object to see whether they are close. If they are close, it implies that the object feature statistic information H(t) at current time t has a short distance from the object feature statistic information H(t−n) of previous n videos, and is within the threshold thl of the similarity between the object and the previous n videos. In other words, |H(t)−H(t−n)|<thl. Hence, the object in the previous n videos and the object in the current video are the same object, which implies that the object is not occluded, as shown in step 303.

If the distance between the object feature statistic information H(t) at current time t and the object feature statistic information H(t−n) of previous n videos is greater than the threshold thl, the occlusion has occurred, and further analysis is required to determine which type of occlusion has occurred. As aforementioned, there are two types of occlusion. The first is the object occluded by another neighboring object, and the second type is the object is occluded by the background, i.e., the object is merged with the other objects.

In step 304, it is to compare the object feature statistic information H(t) at current time t with the feature statistic information Ho(t) of a neighboring object at time t. If H(t) and Ho(t) are close, it implies that the object is merged with another object, as shown in step 305. Otherwise, it implies the object is occluded by another static object, as shown in step 306. In other words, when the distance between H(t) and Ho(t) is less than a predefined second threshold, the object is merged with another object. When the distance between H(t) and Ho(t) is greater than the predefined second threshold, it implies that the object is occluded by another static object, such as the background.

FIG. 4 shows an exemplary flowchart of how to determine whether to switch from ellipse detection to object shape detection, consistent with certain embodiments of the present invention. Referring to FIG. 4, in step 401, it is to determine whether the current frame rate (FR) of the video, i.e., the video processing speed, is greater than a predefined threshold. If so, it implies that the current frame rate is high and an update threshold update_th is reset to a fast threshold th_fs, as shown in step 402.

If the frame rate of the video is less than the predefined threshold, the current processing speed is too slow, and the update_th is reset to a slow threshold th_sl, as shown in step 403.

In step 404, whether the frame rate is greater than the update threshold update_th is continuously determined. If so, the ellipse detection is switched back to the object shape detection, as shown in step 405; otherwise, continue the object shape detection, as shown in step 406.

Therefore, when the current frame rate is faster than the predefined update threshold, the update threshold update_th will choose the fast threshold th_fs, and the detection method will switch from ellipse detection to object shape detection. Therefore, the fast threshold th_fs will be bigger. When the current frame rate is slower than the predefined update threshold, the update threshold update_th will choose the slow threshold th_sl, and the detection method will continue object shape detection. Therefore, the slow threshold th_sl will be smaller. When the detection method switches from ellipse detection to object shape detection, the frame rate of the ellipse detection will be changed to the frame rate of the object shape detection.

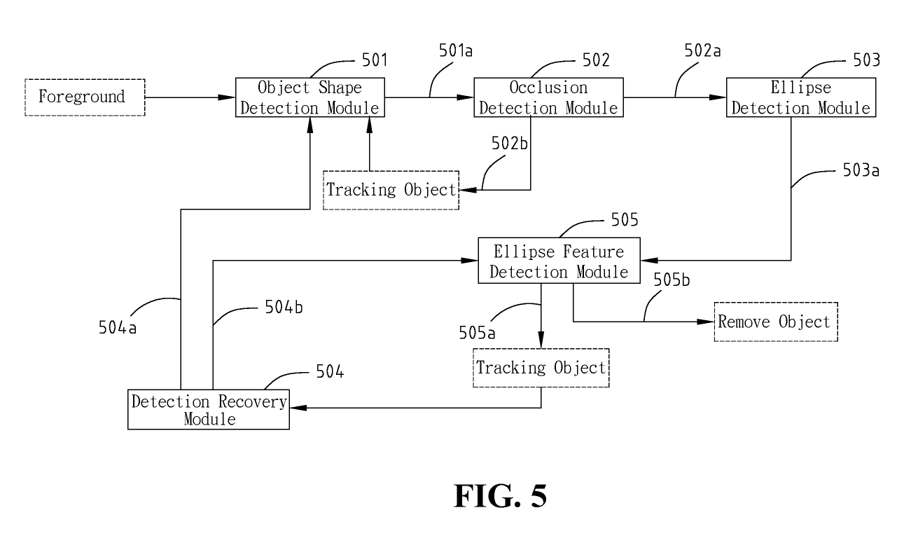

FIG. 5 shows an exemplary schematic view of an apparatus for adaptive object detection, consistent with certain embodiments of the present invention. The apparatus of FIG. 5 is applicable to the detection of the objects with ellipse features. As shown in FIG. 5, the adaptive object detection apparatus comprises an object shape detection module 501, an occlusion detection module 502, an ellipse detection module 503, a detection recovery module 504, and an ellipse feature detection module 505.

Object shape detection module 501 detects the object shape by foreground object shape detection. According to the detected object feature statistic information 501a, occlusion detection module 502 determines whether the object is occluded. As shown by 502a, if the object is occluded, ellipse detection module 503 will perform ellipse detection on the foreground object. As aforementioned, there are two types of occlusion. The first type is the occlusion between an object and another object, and the second type is the merging of an object and another object. When the object is leaving the FOV, ellipse detection module 503 performs the ellipse detection on the foreground object.

Occlusion detection module 502 may use the determination approach of FIG. 3 to determine whether an occlusion has occurred by comparing the current object feature statistic information with the object feature statistic information of previous n videos.

As shown by 502b, if the object is not occluded, continue the object tracking and return to object shape detection module 501 for continuous object tracking.

According to ellipse detection result 503a, ellipse feature detection module 505 detects whether the foreground object has an ellipse feature. As shown by 505b, when the foreground object cannot be detected to have an ellipse feature, the object is treated as noise and is removed. When the foreground object has an ellipse feature, as shown by 505a, the object is continuously tracked, and detection recovery module 504 determines whether to switch the detection method from ellipse detection to object shape detection. If to switch, as shown by 504a, then return to object shape detection module 501. If detection recovery module 504 determines not to switch, as shown by 504b, ellipse feature detection module 505 continues to detect whether the foreground object has an ellipse feature and continues tracking the object.

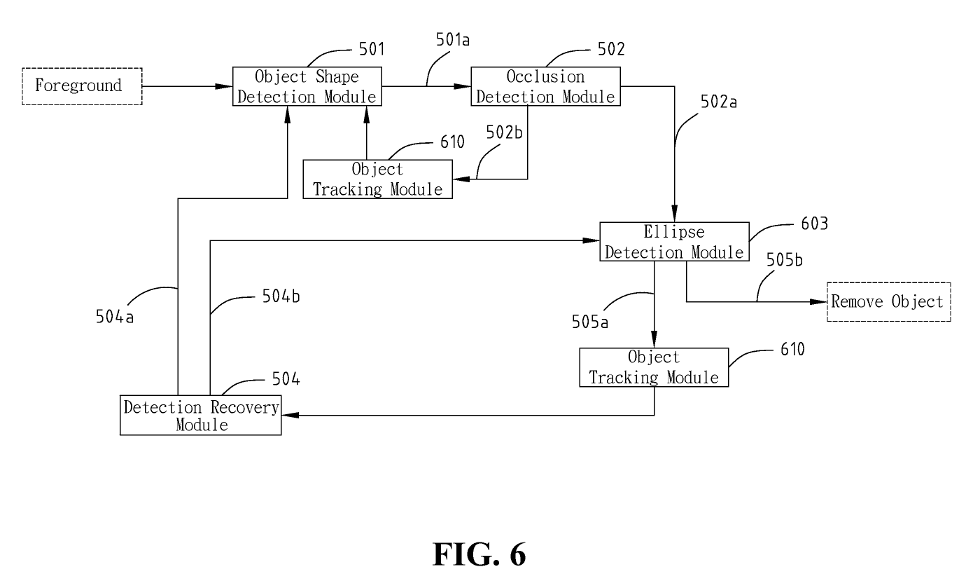

As shown in FIG. 6, the adaptive object detection apparatus may further include an object tracking module 610 for continuous object tracking, including object shape tracking and ellipse feature information tracking. The adaptive object detection apparatus may also integrate ellipse feature detection module 505 with ellipse detection module 503 into an integrated ellipse detection module 603 to detect whether the foreground object has an ellipse feature according to ellipse detection result 503a. When the detected object shape does not satisfy a threshold of the length to width ratio, ellipse detection module 603 performs ellipse detection on the foreground object.

Detection recovery module 504 may use the flowchart of FIG. 4 to determine when to switch from ellipse detection to object shape detection according to whether the current frame rate is greater than an update threshold. When the current frame rate is greater than the update threshold, the detection method is switched to object shape detection module 501 for object shape detection. Otherwise, switch to ellipse feature detection module 505 to continue detecting whether the foreground object has any ellipse feature.

In summary, the disclosed exemplary embodiments of the present invention combine the object shape detection and the ellipse detection. First, find the shape in the video by using object shape detection, and then determine whether the object shape is occluded. If occluded, switch the detection method to ellipse detection for continuous tracking. Once the object shape is no longer occluded, the detection method is switched back to object shape detection. The present invention may further compare the current human feature statistic information against the feature statistic information of the neighboring object for closeness to determine which type of occlusion has occurred. If the closeness is high, the occlusion is an object to object occlusion; otherwise, the occlusion is the object and the background merging. Another situation is when the object moves towards to the camera. In this situation, the disclosed embodiments will also switch the detection method to ellipse detection for continuous tracking.

Although the present invention has been described with reference to the exemplary embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for adaptive object detection, applicable to the detection of an object with an ellipse feature, said method comprising:
performing object shape detection on said object, based on an extracted foreground of said object;
according to the feature statistic information of said detected object, determining whether said object being occluded;
if said object not being occluded, determining whether to switch from object shape detection to ellipse detection;
if said object being occluded or object shape detection having to be switched to ellipse detection, performing ellipse detection on said foreground object;
determining whether said foreground object having an ellipse feature, and when said foreground object having an ellipse feature, continuing tracking said object; and
determining whether to switch from ellipse detection to object shape detection.

2. The method as claimed in claim 1, wherein said object shape detection is switched to ellipse detection if said detected object shape does not satisfy a threshold for a length to width ratio.

3. The method as claimed in claim 2, wherein said object shape detection is switched to ellipse detection when said object is leaving from the field of view.

4. The method as claimed in claim 1, wherein said foreground object is extracted through foreground and background extraction on said object.

5. The method as claimed in claim 1, wherein in the step of determining to switch from ellipse detection to object shape detection, said detection switching is based on the current frame rate of video processing.

6. The method as claimed in claim 1, wherein said foreground object is removed if said foreground object has not been detected to have an ellipse feature or the shape of said foreground object is not detected.

7. The method as claimed in claim 1, wherein when said detected object shape is not occluded, the step of determining whether to switch from object shape detection to ellipse detection further includes:
if said detected object shape greater than a threshold of the length to width ratio, switching from object shape detection to ellipse detection to continue object tracking; and
if said detected object shape not greater than a threshold of the length to width ratio, continuing object shape detection for object tracking.

8. The method as claimed in claim 1, wherein said detected object shape or ellipse feature of said foreground object is used to predict the new location of said object after moving in the next video.

9. The method as claimed in claim 1, wherein the step of determining whether said detected object shape being occluded further includes:
computing feature statistic information of said object at current time;
comparing said feature statistic information of said object at current time with feature statistic information of said same object of previous n videos to determine whether being close, if close, said object not being occluded, otherwise, comparing said feature statistic information of said object at current time with feature statistic information of neighboring object at current time to determine whether being close; and
if said feature statistic information of said object at current time being close to feature statistic information of neighboring object at current time, said object being merging with other objects; otherwise said object being occluded by another static object.

10. The method as claimed in claim 9, wherein said feature statistic information includes the color, texture, boundary or any of the above combination of the foreground object of said object.

11. The method as claimed in claim 1, wherein the step of determining whether to switch from ellipse detection to object shape detection further includes:
determining whether current frame rate for video processing being higher than a predefined threshold;
if current frame rate for video processing being higher than said predefined threshold, setting an update threshold to a fast threshold; otherwise, setting an update threshold to a slow threshold;
determining whether current frame rate for video processing being higher than said update threshold; and
if current frame rate for video processing being higher than said update threshold, switching from ellipse detection to object shape detection; otherwise, continuing object tracking.

12. An apparatus for adaptive object detection, applicable to detecting an object with an ellipse feature, said apparatus comprising:
an object shape detection module for performing object shape detection on said object based on an extracted foreground from said object;
an occlusion detection module for determining whether said object being occluded according to said detected object shape;
an ellipse detection module for performing ellipse detection on said foreground object if said object being occluded or having to switch from object shape detection to ellipse detection;
an ellipse feature detection module for detecting whether said foreground object having an ellipse feature according to said ellipse detection result; and
a detection recovery module for determining whether to switch from ellipse detection to object shape detection.

13. The apparatus as claimed in claim 12, wherein said detection recovery module determines whether to switch from ellipse detection to object shape detection according to the current frame rate of video processing.

14. The apparatus as claimed in claim 12, further includes an object tracking module for continuous tracking of objects.

15. The apparatus as claimed in claim 14, wherein said object tracking includes object shape tracking and object ellipse feature information tracking.

16. The apparatus as claimed in claim 12, wherein when said object is occluded, said occlusion is either between said object and another object, or said object merging with another object.

17. The apparatus as claimed in claim 12, wherein when said object is occluded, said ellipse detection module performs ellipse detection on said foreground object.

18. The apparatus as claimed in claim 12, wherein said occlusion detection module compares current feature statistic information of said object with feature statistic information of said object in previous n videos to determine whether said object is occluded.

19. An apparatus for adaptive object detection, applicable to detecting an object with an ellipse feature, said apparatus comprising:
an object shape detection module for performing object shape detection on said object based on the extracted foreground from said object;
an occlusion detection module for determining whether said object being occluded according to said detected object shape;
an ellipse detection module for performing ellipse detection on said foreground object if said object being occluded or having to switch from object shape detection to ellipse detection;
an ellipse feature detection module for detecting whether said foreground object having an ellipse feature according to said ellipse detection result;
a detection recovery module for determining whether to switch from ellipse detection to object shape detection; and
an object tracking module for continuous tracking of objects.

20. The apparatus as claimed in claim 19, wherein said object tracking further includes object shape tracking and object ellipse feature information tracking.

21. The apparatus as claimed in claim 19, wherein said occlusion detection module compares current feature statistic information of said object with feature statistic information of said object in previous n videos to determine whether said object is occluded.

22. The apparatus as claimed in claim 19, wherein said detection recovery module determines whether to switch from ellipse detection to object shape detection according to the current frame rate of video processing.

23. The apparatus as claimed in claim 19, wherein said ellipse detection module performs ellipse detection on said foreground object when said detected object shape does not satisfy a threshold of the length to width ratio.
